(19) United States
(12) Patent Application Publication
(10) Pub. No.: US 2014/0214960 A1
(43) Pub. Date: Jul. 31, 2014

(54) METHODS AND SYSTEMS FOR TARGETING QUERY MESSAGES IN A SOCIAL GRAPH

(71) Applicant: Linkedln Corporation, Mountain View, CA (US)

(72) Inventors: Christina Allen, Palo Alto, CA (US); Farid Hosseini, San Francisco, CA (US); Seth McLaughlin, Palo Alto, CA (US)

(73) Assignee: Linkedln Corporation, Mountain View, CA (US)

(21) Appl. No.: 14/167,363

(22) Filed: Jan. 29, 2014

Related U.S. Application Data
(60) Provisional application No. 61/759,303, filed on Jan. 31, 2013.

(51) Int. Cl. H04L 29/08

(52) U.S. Cl. CPC H04L 67/22
USPC 709/204

(57) ABSTRACT

Techniques for communicating a query message to a target audience within a social graph are described. Consistent with some embodiments, content to be published as a query message is received. The content may be published on behalf of a first member of a social graph maintained by a social network system. Further, a selection of a skill attribute capable of being listed with one or more members of the social network service is also received. A second member of the social graph is identified based on the second member listing the selected skill attribute. Responsive to identifying the second member, the content from the query message is then published in a personalized content stream accessible to the second member.

### TECHNICAL FIELD

The present disclosure generally relates to data processing systems. More specifically, the present disclosure relates to methods, systems, and computer program products for targeting a message (e.g., a question) to members of a social network.

### BACKGROUND

Online or web-based social network services provide their users with a mechanism for defining, and memorializing in a digital format, their relationships with other people. This digital representation of real-world relationships is frequently referred to as a social graph. As these social network services have matured, many of the services have expanded the concept of a social graph to enable users to establish or define relationships or associations with any number of entities and/or objects in much the same way that users define relationships with other people. For instance, with some social network services and/or with some web-based applications that leverage a social graph that is maintained by a third-party social network service, users can indicate a relationship or association with a variety of real-world entities and/or objects. For example, users may take action to expressly indicate a favorable opinion of, or an interest in, different types of content (e.g., web-based articles, blog postings, books, photographs, videos, audio recordings, music, and so forth). Typically, a user's expression of opinion or interest is captured when a user interacts with a particular graphical user interface element, such as a button, which is generally presented in connection with the particular entity or object and frequently labelled in some meaningful way (e.g., “like”, “−1”, “follow”).

In addition to hosting a vast amount of social graph data, many social network services maintain a variety of personal information about their members. For instance, with many social network services, when a user registers to become a member, the member is prompted to provide a variety of personal or biographical information, which may be displayed in a member's personal web page. Such information is commonly referred to as personal profile information, or simply “profile information,” and when shown collectively, it is commonly referred to as a member's profile. For instance, with some of the many social network services in use today, the personal information that is commonly requested and displayed as part of a member's profile includes a person's age, birthdate, gender, interests, contact information, residential address, home town and/or state, the name of the person's spouse and/or family members, and so forth. With certain social network services, such as some business or professional network services, a member's personal information may include information commonly included in a professional resume or curriculum vitae, such as information about a person's education, the company at which a person is employed, an industry in which a person is employed, a job title or function, an employment history, skills possessed by a person, professional organizations of which a person is a member, and so on.

Because social network services can provide a platform for connecting various users, members of the social network service find it useful to utilize services of the social network service to communicate information to other members. Accordingly, many social network services provide various communication channels by which one member can broadcast content to other members of their social graph, such as status updates, wall posts, shares, likes, and the like. However, many users find these communication channels to be annoying (e.g., many users may receive status updates that are of no interest to them) or too public. Consequently, the effectiveness of these conventional communication techniques is limited.

### DESCRIPTION OF THE DRAWINGS

Some embodiments are illustrated by way of example and not limitation in the FIGS. of the accompanying drawings, in which:

FIG. 1 is a block diagram illustrating various components or functional modules of a social network service, consistent with some embodiments;

FIG. 2 is a data diagram illustrating a data model utilized by an example embodiment;

FIG. 3 is a user interface diagram illustrating an example of a user interface or web page for submitting a query message, consistent with some embodiments;

FIG. 4 is a user interface diagram illustrating an example of a user interface or web page for selecting one or more skill attributes usable in targeting a query message within a social graph, according to an example embodiment;

FIG. 5 is a user interface diagram illustrating an example of a user interface or web page presenting content from a query message to a targeted member profile, according to an example embodiment;

FIG. 6 is a user interface diagram illustrating an example of a user interface or webpage displaying an update to a querying member's profile based on a response message submitted by a responding member, according to an example embodiment;

FIG. 7 is a user interface diagram illustrating an example of a user interface presenting content associated with a member profile belonging to a responding member, according to an example embodiment;

FIG. 8 is a user interface diagram showing a user interface presenting response messages, organized by a query message, according to an example embodiment;

FIG. 9 is a flow diagram illustrating a method of targeting members of a social network service to receive a query message, according to an example embodiment;

FIG. 10 is a flow diagram illustrating a method of generating a response message, according to some embodiments of the invention; and

FIG. 11 is a block diagram of a machine in the form of a computing device within which a set of instructions, for causing the machine to perform any one or more of the methodologies discussed herein, may be executed.

### DETAILED DESCRIPTION

The present disclosure describes methods, systems and computer program products that individually surface a query message (e.g., a question) to targeted members of a social network service based on user specified skill attributes. In the following description, for purposes of explanation, numerous specific details are set forth in order to provide a thorough understanding of the various aspects of different embodiments of the present invention. It will be evident, however, to one skilled in the art, that the present invention may be practiced without all of the specific details.

Consistent with some embodiments, a social network service provides members (e.g., people, companies, schools, government entities, non-profits, or any other suitable type of entity) with a query service that targets, publishes, or otherwise surfaces a question to members of the social network service that may be able to provide meaningful answers to the question posed. For instance, the query service may utilize skill attributes listed by member profiles to identify an audience for a query message submitted by a member. For clarity of description, a member of the social network platform that uses the query service to submit a query message may be referred to as a “querying member.” Further, the term “skill attribute,” as used herein, may refer to data or logic that represents a skill that may be associated with a member profile to indicate that the member associated with the member profile possesses a specified skill or expertise. In some embodiments, a member may select skill attributes to list in their member profile and, additionally or alternatively, members may select skill attributes to list in other member profiles, referred to as endorsing.

In some instances, the web pages are customizable by one or more members of the social network system, but are generally hosted by the provider of the social network system. The web page for a member may be semi-structured, such that a representative of the member can simply enter or input various items of information, and the resulting web page will present the information in various content modules having a uniform look and feel that is determined by the social network system.

With some embodiments, a member's presence within the social network system may be facilitated by representation of the member as an entity in a social graph maintained by the social network system. For example, consistent with some embodiments, a social graph is implemented with a specialized graph data structure in which various entities (e.g., people, companies, schools, government institutions, non-profits, and skills) are represented as nodes connected by edges, where the edges have different types representing the various associations and/or relationships between the different entities. Although other techniques may be used, with some embodiments the social graph data structure is implemented with a graph database. Accordingly, if a member of the social network service with the name Ben Smith knows C++, this particular association would be represented in the social graph data structure by a node representing the member, Ben, being connected via an edge to another node representing the skill attribute, C++, where the particular edge type indicates the specific type of association—in this case, Jeffrey's status as someone skilled in the C++ programming language. Consequently, at least with some embodiments, a skill attribute may have a presence within a social graph of a social network system without necessarily having any particular web-based content that is hosted by the social network service.

Consistent with some embodiments, certain members of a social network service can publish messages (referred to herein as “query messages”) that are viewable to other members of the social network system via one or more data feeds or content streams. A data feed or content stream consistent with embodiments of the invention may be known to those skilled in the art by a variety of different names, including a “stream,” “status update stream,” “network update stream,” and/or “news feed.” Similarly, skilled artisans may refer to this type of message by many different names, including a “status update,” “tweet,” or simply, and generically, as a message. In any case, when a member causes the social network system to publish a query message, the query message may appear in a content stream presented on the web page of other members of the social network system. As discussed in greater detail, some embodiments may alternatively or additionally publish the query message to any suitable communication channel (e.g., such as email, SMS text message, voice mail, push notification on an operating system of a mobile device, for example, and the like). In some cases, such messages may be communicated responsive to triggers, such as a determination that the query message is relevant to a particular skill, profile attributes of the sender or recipient, and the like.

In many instances, a member may have an extremely large number of connections in their social graph. However, there may be circumstances under which a member intends to reach a limited audience or a specific set of members with a particular query message. For instance, a member may desire to publish a query message that is relevant only to those members that know how to program in C++. Such may be the case when the querying member has a question about the syntax or operation of the C++ programming language. Accordingly, consistent with some embodiments of the invention, the social network system includes a targeting module that enables a querying member to specify a skill attribute for the purpose of selecting the members who will receive the query message in a content stream personalized for the member.

With some embodiments, the targeting module may provide a graphical user interface that enables the querying member to select various skill attributes in the social network system to target members who have listed skill attributes that match the selected skill attribute. For example, a querying member may associate a skill attribute with a query message being submitted by selecting or otherwise interacting with a graphical user interface element (e.g., a selection box) presented on a web page in connection submitting the query message. The graphical user interface element (e.g., the selection box) may include a list of skill attributes that may be linked to member profiles of the social network system. In other instances, the graphical user interface element (e.g., the selection box) may include a list of skill attributes that may be linked to member profiles of the querying member's social graph. For example, if the querying member has a connection to another member that lists C++ as a skill, the graphical user interface element (e.g., the selection box) may present C++ as a skill attribute that may be associated with the query message. Upon receiving the query message and the selection of the skill attribute, the social network system may then identify a set of member profiles that list a skill attribute that matches the selected skill attribute. Responsive to identifying the set of members, the social network system may then publish content from the query message in a personalized content stream accessible to the members of the set.

It is to be appreciated that although the above may be described with respect to surfacing query messages to members of another member's social graph, it is contemplated that other embodiments may broadly surface query messages to any member of a social networking service, independent of the member connections between the querying member and the receiving member.

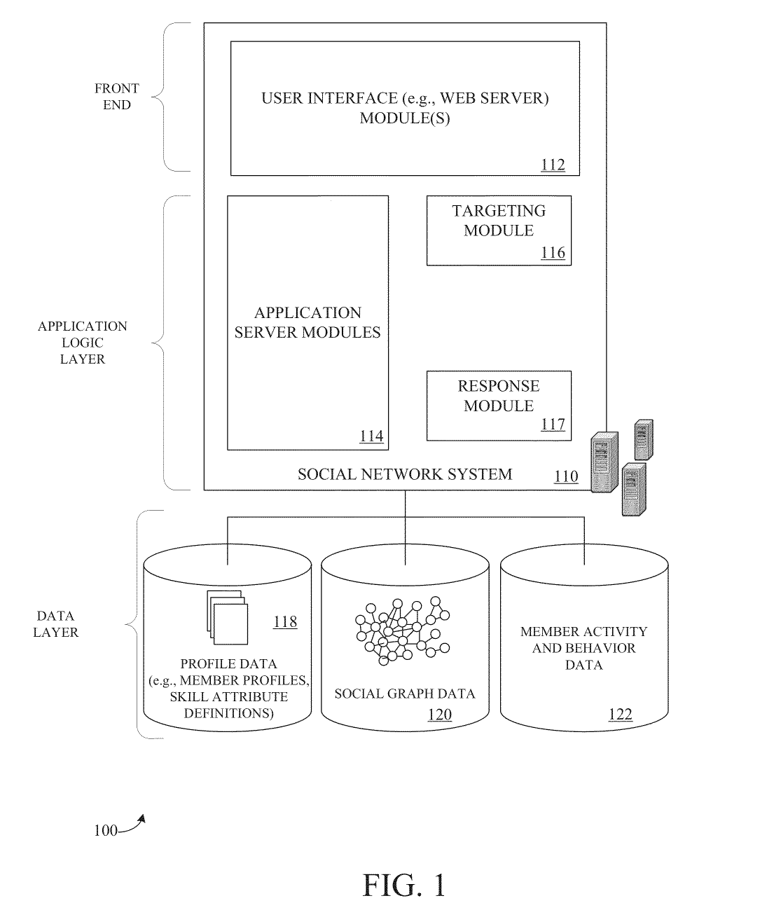

FIG. 1 is a block diagram illustrating various components or functional modules of a social network service 100, consistent with some embodiments. As shown in FIG. 1, the front end consists of a user interface module (e.g., a web server) 112, which receives requests from various client-computing devices, and communicates appropriate responses to the requesting client devices. For example, the user interface module(s) 112 may receive requests in the form of Hypertext Transport Protocol (HTTP) requests, or other web-based, application programming interface (API) requests. The application logic layer includes various application server modules 114, which, in conjunction with the user interface module(s) 112, generates various user interfaces (e.g., web pages) with data retrieved from various data sources in the data layer. With some embodiments, individual application server modules 114 are used to implement the functionality associated with various services and features of the social network service. For instance, the ability of a source member to submit a query message to other members within the social graph of the social network service, including the ability to targeting the query message based on skill attributes linked to member profiles, may be services implemented in independent application server modules 114. Similarly, a variety of other applications or services that are made available to members of the social network service will be embodied in their own application server modules 114. For example, with some embodiments, the social network system 110 includes a targeting module 116 and a response module 117. The targeting module 116 may be a computer-implemented module configured to enables a querying member to surface a query message to a set of recipients that are selected based on skill attributes listed by their respective member profiles. Accordingly, a member can communicate a query to a subset of members that may provide relevant answers. Because the query messages are targeted, the selected members are more likely to find the content of the query message to be of interest and the overall level of engagement is increased.

The response module 117 may be a computer-implemented module configured to enable a responding member to respond to the query message with a response message. In some embodiments, the response module 117 may be configured to update a skill value associated with a skill attribute listed by the responding member's member profile. Accordingly, a member can be rewarded within the social network based on responses the responding member contributes to social network. Because some embodiments of the response module 117 update a skill value associated with the responding member, the response module 117 incentivizes the members to respond to other member's queries. Further, the skill value provides a mechanism for other members to verify the skill attributes listed on a member profile.

As shown in FIG. 1, the data layer includes several databases, such as a database 118 for storing profile data, including both member profile data as well as skill attribute definitions. Consistent with some embodiments, when a person initially registers to become a member of the social network service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database with reference number 118.

Further, the social network service may allow users (e.g., member or administrators of the social network service) to define skill attribute definitions (or just simply “skill attributes”) used within the social network service to indicate a skill or expertise a member may possess. The skill attributes may be stored, for example, in the database with reference number 118, or another database (not shown).

Once registered, a member may invite other members, or be invited by other members, to connect via the social network service. A “connection” may require a bi-lateral agreement by the members, such that both members acknowledge the establishment of the connection. Additionally or alternatively, with some embodiments, a member may elect to list a skill attribute by establishing a link between their member profile and a skill attribute. In some embodiments, the link between the member profile and the skill attribute may be initiated by the owner of the member profile or another member (e.g., a connection of the member profile). When one member lists a skill attribute for another, the member who is listing the skill attribute be referred to as a “skill recommendation,” as used herein.

The various associations and relationships that the members establish with other members, or with other entities and skill attributes, are stored and maintained within the social graph, shown in FIG. 1 with reference number 120.

With some embodiments, the profile data may be processed (e.g., in the background or offline) to generate various derived profile data or derived associations and relationships. For example, if a member has provided information about various job titles the member has held with the same or different companies and for how long, this information can be used to infer, derive, or suggest a link to a skill attribute.

The social network service may provide a broad range of other applications and services that allow members the opportunity to share and receive information, often customized to the interests of the member. For example, with some embodiments, the social network service may include a photo sharing application that allows members to upload and share photos with other members. With some embodiments, members may be able to self-organize into groups, or interest groups, organized around a subject matter or topic of interest. With some embodiments, the social network service may host various job listings providing details of job openings with various organizations.

As members interact with the various applications, services and content made available via the social network service, the members' behavior (e.g., content viewed, links selected, etc.) may be monitored and information concerning the member's behavior may be stored, for example, as indicated in FIG. 1 by the database with reference number 122. This information may be used to classify the member as being in various categories. For example, if the member performs frequent searches of job listings, thereby exhibiting behavior indicating that the member is a likely job seeker, this information can be used to classify the member as a job seeker. This classification can then be used as a member profile attribute for purposes of enabling others to target the member for receiving messages or status updates. Accordingly, a company that has available job openings can publish a message that is specifically directed to certain members of the social network service who are job seekers, and thus, more likely to be receptive to recruiting efforts.

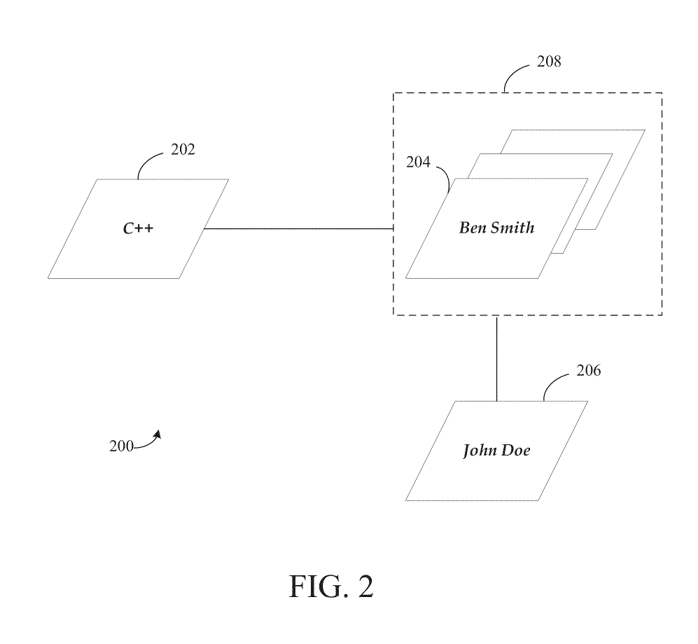

FIG. 2 is a data diagram illustrating a data model 200 utilized by an example embodiment. The data model 200 may conceptually describe the data and relationships stored in databases 118, 120. For example, as illustrated in FIG. 2, the data model 200 may include a skill attribute 202, member profiles 204, 206. As described above, the skill attribute 202 may be data or logic representing a professional skill or ability that a member of the social networking service may advertise to other members. FIG. 2 shows that the skill attribute 202 represents the skill of C++. In terms of the data model, the social networking service lists a skill for a member profile by creating a link that relates a skill attribute to the member profile. For example, the skill attribute 202 is linked to the member profile 204 belonging to Ben Smith. Accordingly, the member profile 204 for Ben Smith lists C++ as a skill possessed by Ben Smith.

FIG. 2 illustrates that many member profiles 208 may list the skill attribute 202.

Additionally, FIG. 2 illustrates that the data model 200 may include data representing a relationship between member profiles, as was described above. For example, the member profile 206 (e.g., John Doe) and the member profiles 208, including the member profile 204 belonging to Ben Smith, may represent a connection, friendship, business relationship, or any other suitable business relationship. Member profiles connected in this way may be said to form a social graph, according to example embodiments.

It is to be appreciated that the data model 200 shown in FIG.2 is provided merely for illustration. Some embodiments may use different data models and still be consistent with this disclosure. For example, some embodiments may represent skill attributes as a property within a member profile, rather than a separate data object. In such embodiments, the social networking service may list a skill property by updating the member profile in such a way that the appropriate property is set with a value representing the skill, for example.

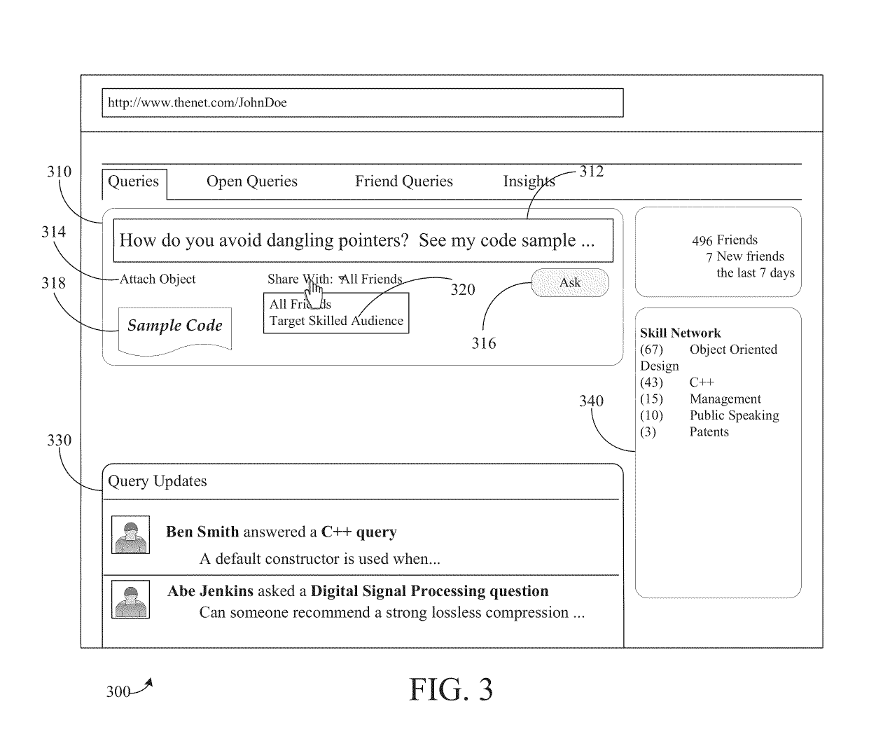

FIG. 3 is a user interface diagram illustrating an example of a user interface 300 or web page for submitting a query message, consistent with some embodiments. As illustrated in FIG. 3, the social networking service may have generated the user interface 300 for a particular member profile previously registered or otherwise created for John Doe. In this example, the user interface 300 for John Doe is hosted by the social network service. In an example use case, John Doe may access the user interface 300 to submit a query message to a social graph associated with his member profile (e.g., via query message submission interface 310), or to review updates regarding query messages submitted by him or connections within his social graph (e.g., via query status interface 330). For example, utilizing the query message submission interface 310, John Doe (or the “querying member”) may log into the social networking system and enter content to be submitted as a query message. Such content may include text entered by the querying member via the text box 312 and, in some cases, an attached or referenced data object (e.g., a directory path, uniform resource locator (URL), a copy of a file, or any other suitable data object) via an attachment button 314. Responsive to selecting the query submit button 316, the social networking service may submit the query to the social network system 110. According to the example input shown in FIG. 3, the content of the query message may include the user entered text, “How do you avoid dangling pointers? See my code sample . . . ”, and a user selected data object 318 that contains sample code. Attaching a data object, such as a file, may provide a comparatively convenient method of providing context to a question posed by the user entered text.

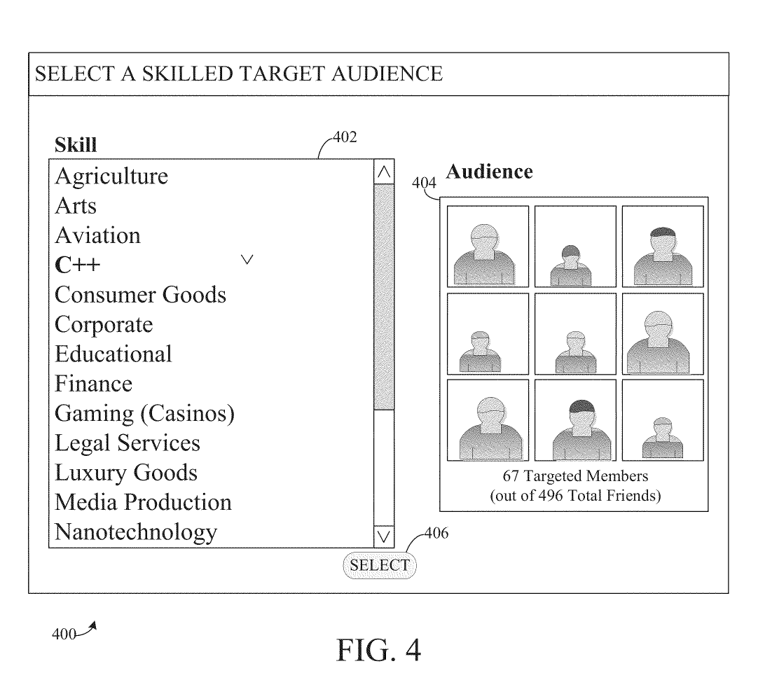

As described above, the social network system 110 may allow a querying member to target other members within a social graph based on skill attributes listed by member profiles associated with the querying member's social graph. For example, the query message submission interface 310 may include a targeting button 320 that is used to initiate member targeting based on skill attributes. For example, upon selecting the targeting button 320, the social network system 110 may present an interface to the querying member in which the querying member may select one or more skill attributes for the targeting. Such a targeting interface is described in greater detail below with reference to FIG. 4.

Continuing with FIG. 3, the query status interface 330 presents a view of query messages and response messages being submitted within the social network associated with the active member. As used herein, an active member is a term used to denote the member of the social network system 110 that is logged into the social networking service. In the example shown in FIG. 3, the active member is John Doe. In example embodiments, the query status interface 330 presents a response message submitted by Ben Smith regarding a query message regarding the skill attribute C++, and Jane Doe submitted a query message regarding the skill attribute Digital Signal Processing. Although not shown in FIG. 3, the query status interface 330 may allow a user to filter the social graph such that the query status interface 330 only shows query messages pertaining to selected skill attributes, members, or any combination thereof.

The skill network module 340 may be an element of the user interface 300 the presents information regarding the skill attributes listed by member profiles in the social graph associated with the active member. For example, FIG. 3 shows that the social graph associated with John Doe include 67 member profiles listing the Object Oriented Design skill attribute, 43 member profiles listing the C++ skill attribute, 15 member profiles listing the Management skill attribute, 10 member profiles listing the Public Speaking skill attribute, and 3 member profiles listing the Patents skill attribute.

FIG. 4 is a user interface diagram illustrating an example of a user interface 400 or web page for selecting one or more skill attributes usable in targeting a query message within a social graph, according to an example embodiment. As FIG. 4 illustrates, the user interface 400 includes a skill attribute selector module 402, an audience presentation module 404, and a submission button 406. The skill attribute selector module 402 may present user selectable skill attributes that a querying member (e.g., John Doe) may select for use in targeting a query message within a social graph. In some embodiments, the social network system 110 (e.g., the targeting module 116 of FIG. 1) may present user selectable skill attributes in the skill attribute selector module 402 based on skill attributes defined by, for example, a skill attribute catalog or any other suitable data structure that maintains the skill attributes defined within the social network system 110, as may be stored in the database 118 of FIG. 1. In other embodiments, the social network system 110 (e.g., the targeting module 116 of FIG. 1) may present skill attributes listed by member profiles of connections within the social graph of the query submitter. In yet another embodiment, the social network system 110 (e.g., the targeting module 116 of FIG. 1) may present skill attributes based on content entered by query submitter in the text box 312 of FIG. 3. For example, the social network system 110 (e.g., the targeting module 116 of FIG. 1) may access data or logic that defines relationships between keywords and skill attributes to suggest skill attributes that may be relevant to the content of the query message. To illustrate, the social network system 110 (e.g., the targeting module 116 of FIG. 1) may access a relationship between the key work “pointer” and C++. Accordingly, the C++ skill attribute may be presented in the skill attribute selector module 402 based on a query message asking “How do you avoid dangling pointers? See my code sample . . . ”

The audience presentation module 404 may select and present connections of the querying member based on the skill attribute(s) selected in the skill attribute selector module 402. For example, as FIG. 4 shows, the audience presentation module 404 may display the member profiles that list C++ as a skill attribute. In some embodiments, the audience presentation module 404 may display a target size that provides an indication of how many member profiles match list selected skill attribute.

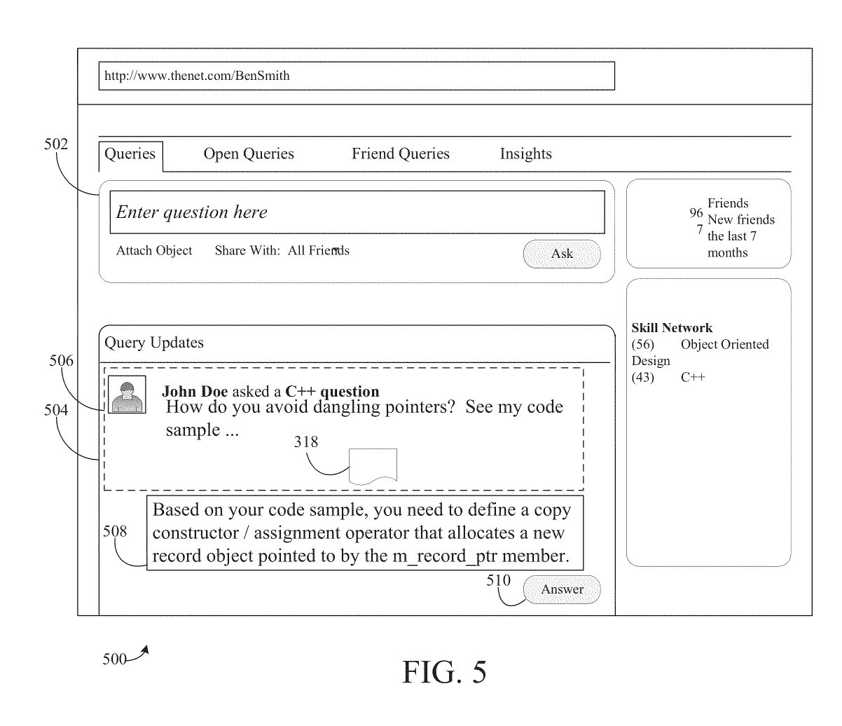

As previously described above with reference to FIG. 3, the social network system 110 may publish a query message to the querying member's social graph responsive to the querying member entering content (e.g., a question) in the text box 312 and then selecting (e.g., clicking) the query submit button 316. Once the query message is submitted to the social network system 110, the social network system 110 may surface the query message to targeted member profiles based at least in part on the skill attributes listed by the targeted member profiles and the skill attribute selected for the query message. FIG. 5 is a user interface diagram illustrating an example of a user interface 500 or web page presenting content from a query message to a targeted member profile, belonging to Ben Smith, for example. In an example embodiment, the user interface 500 may be presented to a targeted member profile responsive to the targeted member profile accessing their account maintained by the social network system 110. As depicted by FIG. 5, the user interface 500 may include, among other things, a query message submission module 502 and a query surfacing module 504. Similar to the query message submission interface 310 of FIG. 3, the query message submission module 502 may be used by member profile to submit a query message to a social graph associated with his member profile.

The query surfacing module 504 may be a user interface element within the user interface 500 which is configured to display query messages targeted to the member profile of the active member. In the case of FIG. 5, Ben Smith is logged into the social network system 110 and, as a result, is the active member. The query surfacing module 504 may include query message content 506, a query response module 508, and a query response submission module 510. The query message content 506 may display contents derived from the query message. For example, the query message content 506 may display the text “How do you avoid dangling pointers? See my code sample . . . ” as was entered by the querying member (e.g., John Doe) via the user interface 300 of FIG. 3. As FIG. 5 shows, the query message content 506 may further include the data object 318 as may also have been entered by the querying member via the user interface 300 of FIG. 3.

The query response module 508 may be a user interface element configured to receive content representing a response to a query message. In some embodiment, the content entered in the query response module 508 may be an answer to a question posed by the query message. As shown in FIG. 5, the responding member entered the following answer to the question posed in the query message content 506: “Based on your code sample, you need to define a copy constructor/assignment operator that allocates a new record object pointed to by the m_record_ptr member.” Although not shown in FIG. 5, the query response module 508 may include one or more user interface element configured to add data objects, such as files, links, and the like.

The query response submission module 510 may be a user interface element configured to submit the content entered by the active member to the social networking service. Responsive to the responding member selecting the query response submission module 510, the social network system 110 may update a skill attribute score associated with a skill attribute listed by the responding member's member profile. As used herein, the term “skill attribute score” may refer to data or logic that indicates a level of expertise for a given skill attribute. An alphanumerical score, badge, or the like are examples of data or logic that may be used to indicate a level of expertise. Accordingly, the social networking service may update a skill attribute listed on the responding member's member profile and that also matches a skill attribute selected for the query message submitted by the querying member.

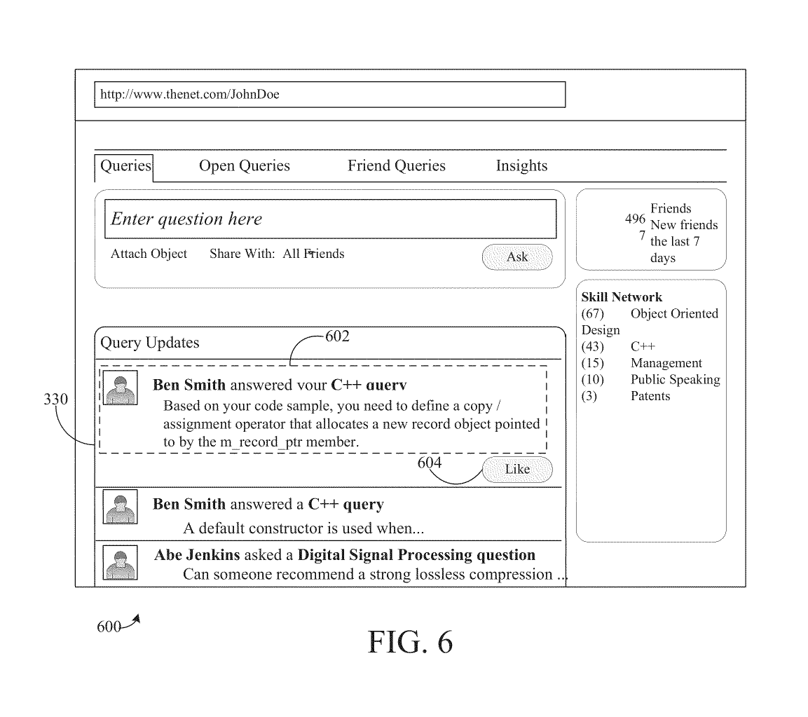

Further, once the responding member submits the response message, the social network system 110 may update the member profile belonging to the querying member. For example, FIG. 6 is a user interface diagram illustrating an example of a user interface 600 or webpage displaying an update to a querying member's profile based on a response message submitted by a responding member, according to an example embodiment. The user interface 600 may present updated content derived from a response message submitted by a responding member through the user interface 500 shown in FIG. 5. For example, the user interface 600 may include the query status interface 330 described above with respect to FIG. 3. As FIG. 6 shows, the query status interface 330 may display content 602 from the response message submitted by the responding member (e.g., Ben Smith), such as a profile image associated with the responding member, an identifier associated with the responding member (e.g., a name, such as Ben Smith), a skill attribute associated with the query message, content of the response message, and the like.

According to some embodiments, the user interface 600 may include a response feedback module 604 associated with the display content 602. The response feedback module 604 may be a user interface element that updates a skill attribute score associated with a skill attribute listed by the responding member. For example, where the skill attribute score is represented by an alphanumerical value, the social network system 110 may increase the alphanumerical number responsive to the querying member, or, in some embodiments, any other member, initiating the response feedback module 604.

It is to be appreciated that as other targeted members submit response messages to the query message, the query status interface 330 may additionally present content derived from those submitted response message in conjunction with the display content 602.

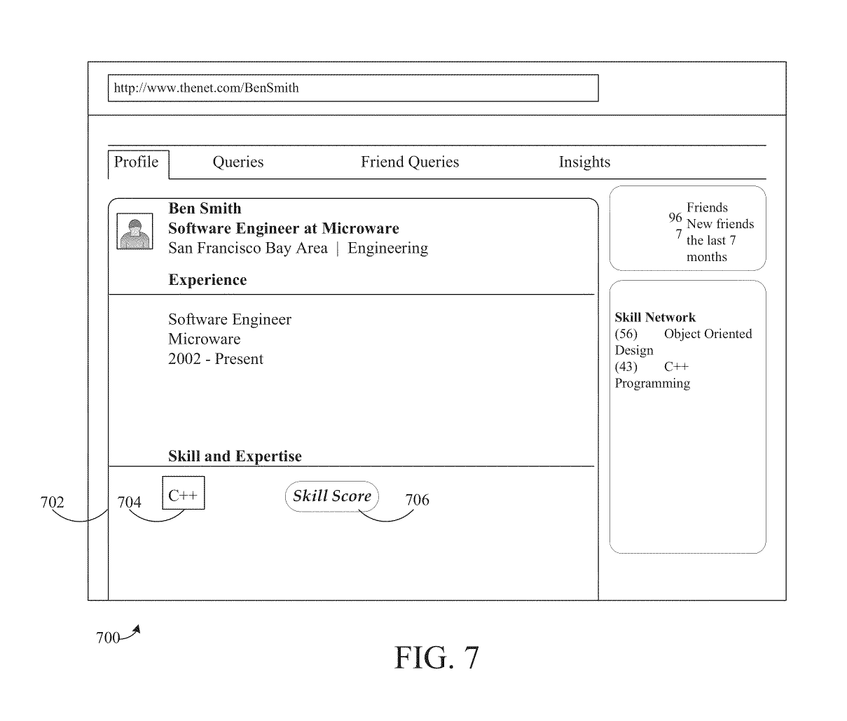

FIG. 7 is a user interface diagram illustrating an example of a user interface 700 presenting content associated with a member profile belonging to a responding member (e.g., Ben Smith), according to an example embodiment. As FIG. 7 shows, the user interface 700 may present member profile information, such as information about the responding member's education, the company at which the responding member is employed, an industry in which the responding member is employed, a job title or function, an employment history, professional organizations of which the responding member is a member, and so on. Further, the user interface 700 may include information regarding the skill attributes listed by the responding member. This is shown in the skill attribute section 702. The skill attribute section 702 may include one or more skill attributes (e.g., skill attribute 704) that identify skill attributes listed by the member and corresponding skill attribute score (e.g., as represented by the skill attribute score indicator 706). As described above, the skill attribute score indicator 706 may provide information regarding a member's expertise with a given skill attribute based on the responding member responding to query messages sent by other members, receiving response votes, and the like. In some embodiments, the social network system 110 may present the response messages, and corresponding query messages, submitted by the member that are associated with the skill attribute in response to a member selecting the skill attribute score indicator 706.

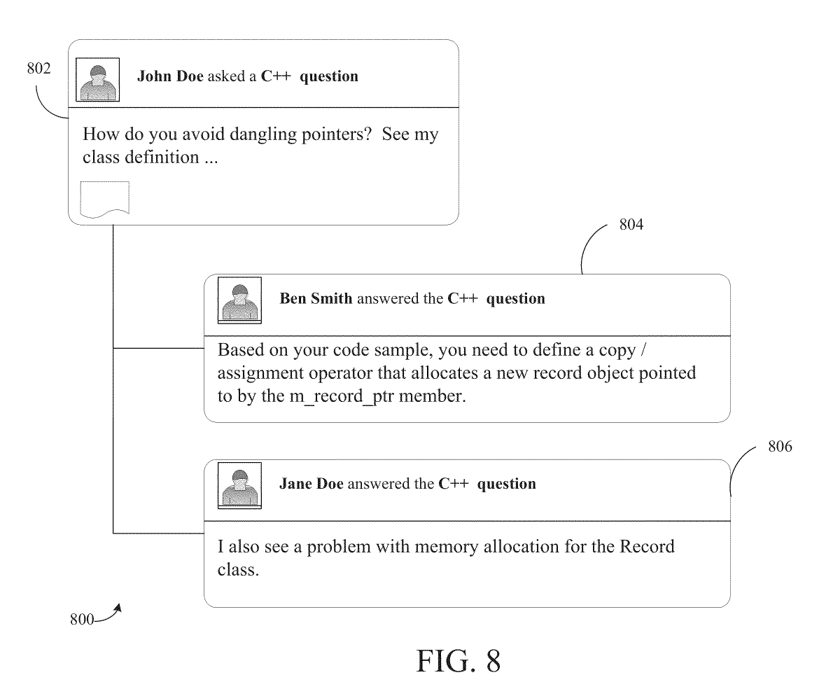

It is to be appreciated that the user interfaces described in this disclosure are meant to be illustrative of example embodiments. Consistent with embodiments contemplated herein, other embodiments may utilize different user interfaces to provide services relating to targeting query messages to a group of members of a social graph based on skill attributes. For example, FIGS. 3, 5, and 6 illustrate user interfaces that presenting query messages and corresponding response messages using an example format. In contrast, FIG. 8 is a user interface diagram showing a user interface 800 presenting response messages 804, 806 organized by a query message 802, according to an example embodiment. The social network system 110 may present the user interface 800 responsive to detecting the user selecting any number of user interface elements from the user interfaces described above, such as display content 602, skill attribute score indicator 706, or any other suitable user interface element.

FIG. 8 shows that the query message 802 may be presented in conjunction with the response messages 804, 806 submitted by multiple responding members, Ben Smith and Jane Doe. For example, the social network system 110 may organize the response messages 804, 806 in a visual tree, where the response messages 804, 806 may be nested under the query message 802. In some embodiments, although not shown in FIG. 8, each of the response messages 804, 806 may include response feedback modules, similar to the response feedback module 604 of FIG. 6, to provide feedback on individual response messages, which in turn may affect the skill attribute score of the responding member profile.

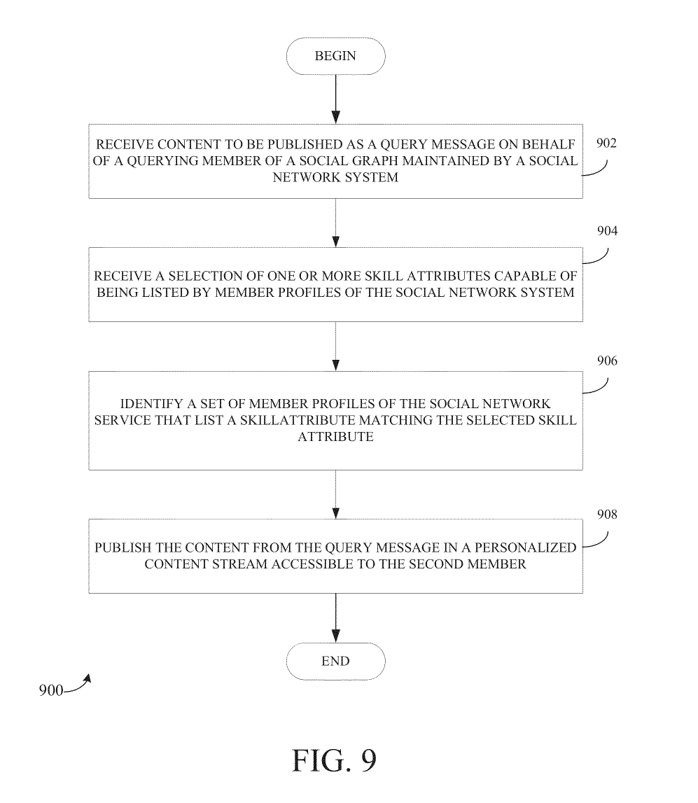

FIG. 9 is a flow diagram illustrating a method 900 of targeting members of a social network service to receive a query message, according to an example embodiment. The method 900 may begin at operation 902 when an application or service (e.g., the targeting module 116) of the social network system 110 receives content (e.g., text, a hyperlink or reference to some web-based content, an audio, photograph, image, or video file, etc.) that is to be published as a query message on behalf of a querying member (e.g., a user, a company, a school, a government entity, a non-profit, or other organization) of a social graph maintained by the social network system 110. In some embodiments, the query message may include content, such as a text string, representing a question and, in some cases, links, references, or copies of data objects, such as data files.

At method operation 904, an application or service (e.g., targeting module 116) of the social network system 110 receives a selection of a skill attribute as targeting criteria capable of being listed by member profiles of the social network system 110. With some embodiments, the skill attributes that are presented for user-selection are displayed based on the skill attributes that are listed by the member profiles that are part of the querying member's social graph. Accordingly, the targeting module 116 may filter out those skill attributes that are not listed by any member profiles within the social graph, according to some embodiments. Additionally or alternatively, the targeting module 116 may suggest skill attributes based on keywords extracted from content in the query message that are related to a skill attribute. By way of example and not limitation, the term constructor may be related to C++ and Java and, accordingly, may be suggested by the targeting module 116.

At operation 906, a set of member profiles of the social graph is identified by an application or service (e.g., targeting module 116) of the social network system 110. With some embodiments, the identification of the set of member profiles may be based at least in part on determining that each member profile from the set of member profiles lists a skill attribute that matches the selected skill attribute. The term “matching,” as used herein, may refer to a determination that two or more skill attributes are equivalent with each other. For example, the targeting module 116 may determine that two skill attributes match when they refer to the same skill attribute (e.g., “C++” is the same as “C++”). In another embodiment, the targeting module 116 may determine that two skill attributes match when the two skill attributes are related to each other. For example, the targeting module may access relationships data that specifies relatedness between skill attributes, such as one skill attribute (C++) is similar to another (e.g., Embedded C++).

At operation 908, the targeting module 116 publishes content from the query message to the set of members identified at operation 906. In some embodiments, publishing the content may involve surfacing the content on a personalized content stream accessible by individual members of the set of members identified at method operation 906. Examples of a content stream include an inbox, status feed, query status feed, SMS text, or any other suitable communication channel. The query surfacing module 504 shown in FIG. 5 is also an example of a content stream.

Although the many examples presented herein involve publishing query messages or status updates to a content stream, in other embodiments, the same targeting logic may be used to communicate query messages using a wide variety of communication channels. For example, the targeting logic described herein may be used to communicate an email message, a text message, or any other type of message. With some embodiments, a messaging interface may allow the query message author to select the particular communication channel (e.g., status update, email, text message, etc.) by which a query message is to be communicated to the desired audience.

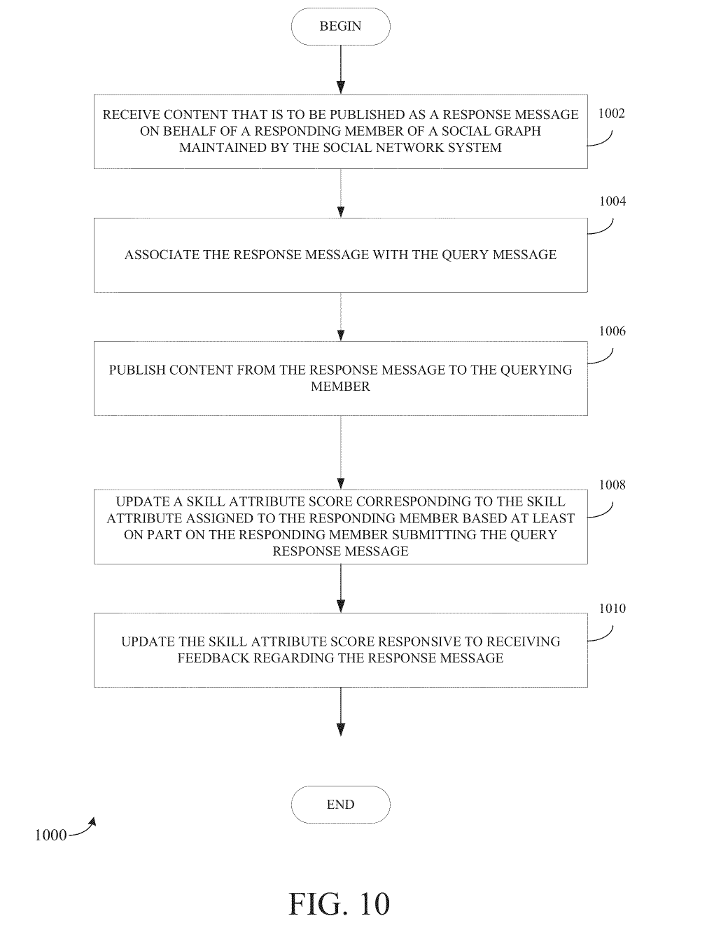

FIG. 10 is a flow diagram illustrating a method 1000 of generating a response message, according to some embodiments of the invention. The method 1000 may begin at operation 1002 when the response module 117 of the social network system 110 receives content (e.g., text, a hyperlink or reference to some web-based content, an audio, photograph, image, or video file, etc.) that is to be published as a response message on behalf of a responding member (e.g., a user, a company, a school, a government entity, a non-profit, or other organization) of a social graph maintained by the social network system 110. In some embodiments, the response message may include content representing an answer to a question posed in a prior query message and, in some cases, links, references, or copies of data objects, such as data files.

At operation 1004, the response module 117 may then associate the response message with the query message using a response relationship. For example, the query response message may be stored as a record that includes a field that points or references to the record representing the query message. Additionally or alternatively, a record representing a response relationship between the query message and the response message may include a field that points or references to the record representing the query message and one or more fields that point or reference other records representing query response messages.

At operation 1006, the response module 117 publishes content from the response message to the querying member and, in some cases, to the set of members identified at operation 906 of FIG. 9. As described above, publishing the content may involve surfacing the content on a personalized content stream accessible by individual members. Examples of a content stream include an inbox, status feed, query status feed, SMS text, or any other suitable communication channel. The query surfacing module 504 shown in FIG. 5 is also an example of a content stream.

At operation 1008, the response module 117 may then update a skill attribute score corresponding to the skill attribute assigned to the responding member based at least on part on the responding member submitting the query response message. As described above, skill attribute score may refer to an attribute of a skill attribute that reflects a user's competency with the skill represented by the skill attribute. In some embodiments, the skill attribute score may be represented as an alphanumerical score (e.g., a number within a range, a letter grade, a level, or some combination thereof), a badge, a ranking, or any other suitable indication of value.

At operation 1010, the response module 117 may receive feedback regarding the response message submitted by the responding member. As an example, the response module 117 may provide one or more members (e.g., the query submitter or any other member) of the social network system 110 a user interface to view the response message, and to provide a feedback of the quality of the query response message. For example, in some embodiments, a member reviewing the query response message may be able to rate the query response message according to a determinable scale (e.g., 1-10, 10 representing the best possible response). Additionally or alternatively, a member reviewing the response message may be able to provide other indications of agreement with the query response message, such as whether the reviewer “likes” the query response message.

Operation 1010 may further involve the response module 117 updating the skill attribute score of the responding member based on the feedback regarding the query response message. For example, the response module 117 may compare the rated score for a query response message against the rated scores of other query response messages responding to the same query message to determine the best query response message (e.g., the query response message with the highest rating). Responsive to determine the highest rated query response message, the response module 117 may then update the skill attribute score for the user that submitted the highest rated query response message.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules or objects that operate to perform one or more operations or functions. The modules and objects referred to herein may, in some example embodiments, comprise processor-implemented modules and/or objects.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

The one or more processors may also operate to support performance of the relevant operations in a “cloud computing” environment or within the context of “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

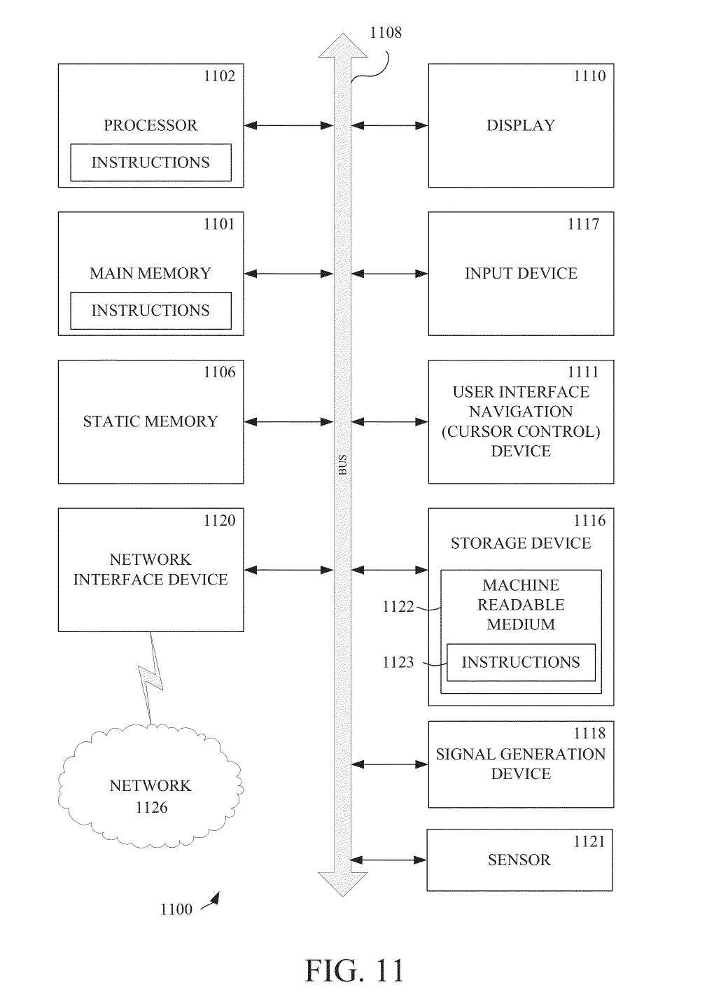

FIG. 11 is a block diagram of a machine in the form of a computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a preferred embodiment, the machine will be a server computer, however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU), a graphics processing unit (GPU) or both), a main memory 1101 and a static memory 1106, which communicate with each other via a bus 1108. The computer system 1100 may further include a display unit 1110, an alphanumeric input device 1117 (e.g., a keyboard), and a user interface (UI) navigation device 1111 (e.g., a mouse). In one embodiment, the display, input device and cursor control device are a touch screen display. The computer system 1100 may additionally include a storage device 1116 (e.g., drive unit), a signal generation device 1118 (e.g., a speaker), a network interface device 1120, and one or more sensors 1121, such as a global positioning system sensor, compass, accelerometer, or other sensor.

The drive unit 1116 includes a machine-readable medium 1122 on which is stored one or more sets of instructions and data structures (e.g., software 1123) embodying or utilized by any one or more of the methodologies or functions described herein. The software 1123 may also reside, completely or at least partially, within the main memory 1101 and/or within the processor 1102 during execution thereof by the computer system 1100, the main memory 1101 and the processor 1102 also constituting machine-readable media.

While the machine-readable medium 1122 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1123 may further be transmitted or received over a communications network 1126 using a transmission medium via the network interface device 1120 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the invention. For example, in some cases, a messages exchanged by systems and methods described herein may status updates rather than query messages. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A computer-implemented method comprising:
receiving, at a processor-implemented targeting module, content to be published as a query message on behalf of a first member of a social graph maintained by a social network system, and a selection of a skill attribute capable of being listed with one or more members of the social network service;
identifying a second member of the social graph based on the second member listing the selected skill attribute; and
responsive to identifying the second member, publishing the content from the query message in a personalized content stream accessible to the second member.

2. The method of claim 1, further comprising, prior to receiving the content to be published as the query message, linking the skill attribute to the second member responsive to receiving a recommendation from a third member of the social network service, the recommendation identifying the skill attribute as a skill possessed by the second member.

3. The method of claim 1, wherein the query message represents a question being posed by the first member to the social graph.

4. The method of claim 1, further comprising:
prior to receiving the selection of the skill attribute, causing a user interface to be presented to the first member, the user interface specifying a plurality of user-selectable skill attributes and facilitating the receiving of the selection of the skill attribute for the members of the social network service.

5. The method of claim 4, wherein the skill attribute is selected from a plurality of the skill attributes, the plurality of skill attributes including at least one member profile attribute that is not explicitly specified or provided by a member of the social network service, but is derived or computed from one or more other member profile attributes.

6. The method of claim 1, further comprising:
receiving a query response message submitted by the second user, the query response message being identified as a response to the query message; and
updating a skill attribute score associated with the skill attribute assigned to the second user based at least in part on the second user submitting the query response message.

7. The method of claim 6, wherein updating the skill attribute score is further based on the query response message being recommended by one or more members of the social network service.

8. The method of claim 6, wherein updating the skill attribute score is further based on the query response message being voted as a best response to the query message.

9. The method of claim 1, further comprising:
subsequent to receiving the selection of the skill attribute, deriving the size of the set of members of the social graph who have the skill attribute listed in a member profile; and
updating a user interface element to display the size of the set of members as the number of members who will receive the query message in their respective personalized content stream when the query message is published.

10. The method of claim 4, wherein the skill attribute is selected from a plurality of the skill attributes, the plurality of skill attributes including at least one member profile attribute that is not explicitly specified or provided by a member of the social network service, but is derived or computed from keywords identified in the content to be published as the query message.

11. A computer system comprising:
at least one processor;
a targeting module implemented by the at least one processor and configured to:
receive, at a processor-implemented targeting module, content to be published as a query message on behalf of a first member of a social graph maintained by a social network system, and a selection of a skill attribute capable of being listed with one or more members of the social network service;
identify a second member of the social graph based on the second member listing the selected skill attribute; and
responsive to identifying the second member, publish the content from the query message in a personalized content stream accessible to the second member.

12. The computer system of claim 11, wherein the targeting module being further configured to, prior to receiving the content to be published as the query message, linking the skill attribute to the second member responsive to receiving a recommendation from a third member of the social network service, the recommendation identifying the skill attribute as a skill possessed by the second member.

13. The computer system of claim 11, wherein the targeting module being further configured to:
prior to receiving the selection of the skill attribute, cause a user interface to be presented to the first member, the user interface specifying a plurality of user-selectable skill attributes and facilitating the receiving of the selection of the skill attribute for the members of the social network service.

14. The computer system of claim 13, wherein the skill attribute is selected from a plurality of the skill attributes, the plurality of skill attributes including at least one member profile attribute that is not explicitly specified or provided by a member of the social network service, but is derived or computed from one or more other member profile attributes.

15. The computer system of claim 11, wherein the targeting module being further configured to:
receive a query response message submitted by the second user, the query response message being identified as a response to the query message; and
update a skill attribute score associated with the skill attribute assigned to the second user based at least in part on the second user submitting the query response message.

16. The computer system of claim 15, wherein updating the skill attribute score is further based on the query response message being recommended by one or more members of the social network service.

17. The computer system of claim 15, wherein updating the skill attribute score is further based on the query response message being voted as a best response to the query message.

18. The computer system of claim 11, wherein the targeting module being further configured to:
subsequent to receiving the selection of the skill attribute, derive the size of the set of members of the social graph who have the skill attribute listed in a member profile; and
update a user interface element to display the size of the set of members as the number of members who will receive the query message in their respective personalized content stream when the query message is published.

19. The computer system of claim 13, wherein the skill attribute is selected from a plurality of the skill attributes, the plurality of skill attributes including at least one member profile attribute that is not explicitly specified or provided by a member of the social network service, but is derived or computed from keywords identified in the content to be published as the query message.

20. A non-transitory computer-readable medium storing executable instructions thereon, which, when executed by a processor, cause the processor to perform operations including:
receiving, at a processor-implemented targeting module, content to be published as a query message on behalf of a first member of a social graph maintained by a social network system, and a selection of a skill attribute capable of being listed with one or more members of the social network service;
identifying a second member of the social graph based on the second member listing the selected skill attribute; and
responsive to identifying the second member, publishing the content from the query message in a personalized content stream accessible to the second member.
